(19) United States
(12) Patent Application Publication
(10) Pub. No.: US 2025/0005544 A1
(43) Pub. Date: Jan. 2, 2025

(54) NON-FUNGIBLE TOKEN-BASED BLOCKCHAIN TRANSACTIONS

(71) Applicant: NFTipay LLC, Lexington, MA (US)

(72) Inventors: Steven Douglas Albrechtsen, Providence, UT (US); Tobias Kleitman, Lexington, MA (US)

(21) Appl. No.: 18/346,153

(22) Filed: Jun. 30, 2023

(51) Int. Cl. G06Q 20/10; G06Q 20/36; G06Q 20/38; G06Q 20/40

(52) U.S. Cl. CPC G06Q 20/10; G06Q 20/3672; G06Q 20/389; G06Q 20/401; G06Q 20/407

(57) ABSTRACT

A method, a system, and computer program product for managing distribution of non-fungible tokens (NFTs) representing receipts for transactions are provided. A request for a transaction is received over a blockchain network. The transaction includes a transfer of assets between a target node to a recipient node, both included in a blockchain network A link to a first transaction operation is transmitted to the recipient node. A token of a first result of the first transaction operation is transmitted, over the blockchain network, to trigger a second transaction operation. A second result of the second transaction operation is received from the blockchain network. A pair of non-fungible tokens including encrypted metadata associated with the transaction including the second result of the transaction operation is generated and transmitted to the target node and the other non-fungible token of the pair of non-fungible tokens to the recipient node.

### TECHNICAL FIELD

The present disclosure generally relates to blockchain transactions and, more specifically, to a distribution of non-fungible tokens (NFTs) representing receipts for blockchain transactions.

### BACKGROUND

Blockchain systems are used to carry out transactions involving assets such as cryptocurrency. In general, blockchain transactions are usually immutable and thus cannot be modified once added to a blockchain. Accordingly, blockchain systems are used in the implementation of transaction systems, in which immutability of blockchain data provides an advantage. In particular, the integrity of data in a blockchain system may be higher than systems, in which data can be more easily modified or erased.

### SUMMARY

Methods, systems, and articles of manufacture, including computer program products, are provided for distribution of non-fungible tokens (NFTs) representing receipts for blockchain transactions. In one aspect, a method includes: receiving a request for a transaction over a blockchain network, the transaction including a transfer of assets between a target node to a recipient node, the target node and the recipient node being included in a blockchain network; transmitting, a link to a first transaction operation to the recipient node; receiving a first result of the first transaction operation from the recipient node; transmitting, over the blockchain network, a token of the first result of the first transaction operation to trigger a second transaction operation; receiving a second result of the second transaction operation from the blockchain network; generating a pair of non-fungible tokens including encrypted metadata associated with the transaction including the second result of the second transaction operation; and transmitting one non-fungible token of the pair of non-fungible tokens to the target node and the other non-fungible token of the pair of non-fungible tokens to the recipient node.

In some variations, one or more features disclosed herein including the following features can optionally be included in any feasible combination. In some implementations, each non-fungible token of the pair of non-fungible tokens includes contact information of the target node and the recipient node (and asset transaction information. In some implementations, the computer-implemented method further includes: determining that the transaction is authorized. In some implementations, determining that the transaction is authorized includes determining that the target node is identified as an entity allowed to perform the second transaction operation. In some implementations, the second transaction operation includes a shipment of at least one of the assets. In some implementations, the computer-implemented method further includes: monitoring completion of the shipment within a set shipment time period. In some implementations, the computer-implemented method further includes: monitoring completion of the first transaction operation, by the recipient node, within a set time period. In some implementations, the computer-implemented method further includes: receiving, from the recipient node, a refund request including an NFT identifying a past transaction; and processing the refund for the past transaction. In some implementations, the computer-implemented method further includes: determining a balance of an account of at least one of the target node and the recipient node. In some implementations, generating the pair of non-fungible tokens is queued in a chain of transactions. In some implementations, the chain of transactions are rearranged based on a history and priority of transactions.

In another aspect, a non-transitory computer-readable storage medium includes programming code, which when executed by at least one data processor, causes operations including: receiving a request for a transaction over a blockchain network, the transaction including a transfer of assets between a target node to a recipient node, the target node and the recipient node being included in a blockchain network; transmitting, a link to a first transaction operation to the recipient node; receiving a first result of the first transaction operation from the recipient node; transmitting, over the blockchain network, a token of the first result of the first transaction operation to trigger a second transaction operation; receiving a second result of the second transaction operation from the blockchain network; generating a pair of non-fungible tokens including encrypted metadata associated with the transaction including the second result of the second transaction operation; and transmitting one non-fungible token of the pair of non-fungible tokens to the target node and the other non-fungible token of the pair of non-fungible tokens to the recipient node.

In some variations, one or more features disclosed herein including the following features can optionally be included in any feasible combination. In some implementations, each non-fungible token of the pair of non-fungible tokens includes contact information of the target node and the recipient node (and asset transaction information. In some implementations, the operations further include: determining that the transaction is authorized. In some implementations, determining that the transaction is authorized includes determining that the target node is identified as an entity allowed to perform the second transaction operation. In some implementations, the second transaction operation includes a shipment of at least one of the assets. In some implementations, the operations further include: monitoring completion of the shipment within a set shipment time period. In some implementations, the operations further include: monitoring completion of the first transaction operation, by the recipient node, within a set time period. In some implementations, the operations further include: receiving, from the recipient node, a refund request including an NFT identifying a past transaction; and processing the refund for the past transaction. In some implementations, the operations further include: determining a balance of an account of at least one of the target node and the recipient node. In some implementations, generating the pair of non-fungible tokens is queued in a chain of transactions. In some implementations, the chain of transactions are rearranged based on a history and priority of transactions.

In another aspect, a system includes: at least one data processor; and at least one memory storing instructions, which when executed by the at least one data processor, cause operations including: receiving a request for a transaction over a blockchain network, the transaction including a transfer of assets between a target node to a recipient node, the target node and the recipient node being included in a blockchain network; transmitting, a link to a first transaction operation to the recipient node; receiving a first result of the first transaction operation from the recipient node; transmitting, over the blockchain network, a token of the first result of the first transaction operation to trigger a second transaction operation; receiving a second result of the second transaction operation from the blockchain network; generating a pair of non-fungible tokens including encrypted metadata associated with the transaction including the second result of the second transaction operation; and transmitting one non-fungible token of the pair of non-fungible tokens to the target node and the other non-fungible token of the pair of non-fungible tokens to the recipient node.

In some variations, one or more features disclosed herein including the following features can optionally be included in any feasible combination. In some implementations, each non-fungible token of the pair of non-fungible tokens includes contact information of the target node and the recipient node (and asset transaction information. In some implementations, the operations further include: determining that the transaction is authorized. In some implementations, determining that the transaction is authorized includes determining that the target node is identified as an entity allowed to perform the second transaction operation. In some implementations, the second transaction operation includes a shipment of at least one of the assets. In some implementations, the operations further include: monitoring completion of the shipment within a set shipment time period. In some implementations, the operations further include: monitoring completion of the first transaction operation, by the recipient node, within a set time period. In some implementations, the operations further include: receiving, from the recipient node, a refund request including an NFT identifying a past transaction; and processing the refund for the past transaction. In some implementations, the operations further include: determining a balance of an account of at least one of the target node and the recipient node. In some implementations, generating the pair of non-fungible tokens is queued in a chain of transactions. In some implementations, the chain of transactions are rearranged based on a history and priority of transactions.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that can include one or more processors and one or more memories coupled to the one or more processors. A memory, which can include a non-transitory computer-readable or machine-readable storage medium, can include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to customization of database tables, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIGS. 1A and 1B depict diagrams illustrating examples of systems, in accordance with some example implementations;

FIG. 2 depicts an example of a database, in accordance with some example implementations;

FIG. 3 depicts an example process for distribution of non-fungible tokens (NFTs) representing receipts for blockchain transactions, in accordance with some example implementations;

FIGS. 4A, 4B, 4C, and 4D depict examples of portions of the process described with reference to FIG. 3, in accordance with some example implementations; and

FIG. 5 depicts a diagram illustrating a computing system, in accordance with some example implementations.

When practical, like labels are used to refer to same or similar items in the drawings.

### DETAILED DESCRIPTION

Implementations of the present disclosure are generally directed to blockchain-based transactions. More particularly, implementations of the present disclosure are directed to distribution of non-fungible tokens (NFTs) representing receipts for blockchain transactions. A blockchain-based system is used to distribute non-fungible tokens (NFTs) representing receipts for transactions. Each buyer and authorized seller accesses a payment software application to create charges and perform payments for selected transactions. NFTs are minted for each of the transactions by executing a receipt contract function. Each payment gateway contract can be tied to a single receipt contract. The receipt contract can include a mapping of other contracts that are allowed to interact with the receipt contract. The other contracts are, e.g., transaction and payment contracts. The receipt contract can also include a seller address associated with a payment gateway contract defining agreements between involved parties (buyers and authorized sellers). Only the payment gateway contracts that are configured in the receipt contract can interact with the receipt contract.

Each time a payment is made to a configured payment gateway contract, the payment is reported to the receipt contract by sending a payment hash. The payment hash can be generated by payment software application (including the payment gateway contract) using an integer nonce, string uniform resource identifier (URI), buyer address (buyer blockchain wallet address), and seller address (seller blockchain wallet address). The payment hash can be deployed, over a blockchain network, using a receipt software application (including a receipt contract) to perform the transaction.

In some implementations, a transaction management application calls a function of the receipt contract that does not require gas (e.g., a blockchain transaction fee) to generate the commitment. The contractual commitment data can be determined by the receipt contract application. In response to determining that the transaction was successful, NFTs are minted by those designated as minting addresses in the receipt that can map to the buyer and seller involved in the transaction. Two tokens are minted for each completed transaction, one of which is provided to the buyer and one of which is provided to the seller. The two tokens respectively have a similar token URI which enable the buyer and the seller, respectively, to access metadata indicative of the transaction data. For example, the NFT pair can include a full URI to the metadata regarding the payment transaction. The NFTs can include (e.g., encrypted or non-encrypted) metadata associated with the transaction records (e.g., email addresses and asset transaction information) and can include one or more security features (e.g., watermarks). In some implementations, the metadata is stored by databases of transaction managing systems, and the NFT URI includes a URL that can be used to retrieve the metadata (e.g., a collection of information extracted throughout the entire transaction event, including data associated with a request for transaction and a request for payment) from the databases (e.g., a public or private distributed file system).

The described implementations herein has advantages over other techniques for minting NFT receipts for blockchain transactions. Some of the advantages of these techniques include secure distribution of transaction data to participants in a privacy preserving and decentralized fashion. Further, the described blockchain-based system uses a payment software application to provide a bridge between ease of use of blockchain payments and self-custody of seller funds. With the payment software application, sellers own their respective contracts at all times (e.g., the contracts are deployed in association with blockchain addresses controlled by the respective sellers). The provider of the payment software application never has access to seller funds, and sellers can withdraw their funds at any time.

Further, the described blockchain-based system enables any number of addresses to be designated as minter addresses. The described blockchain-based system is configured to be able to maintain a large scale and throughput in minting NFTs. The described blockchain-based system is configured to be able to approve/deny minter addresses, while enabling the payment software application to rotate through minting wallets as a security best practice.

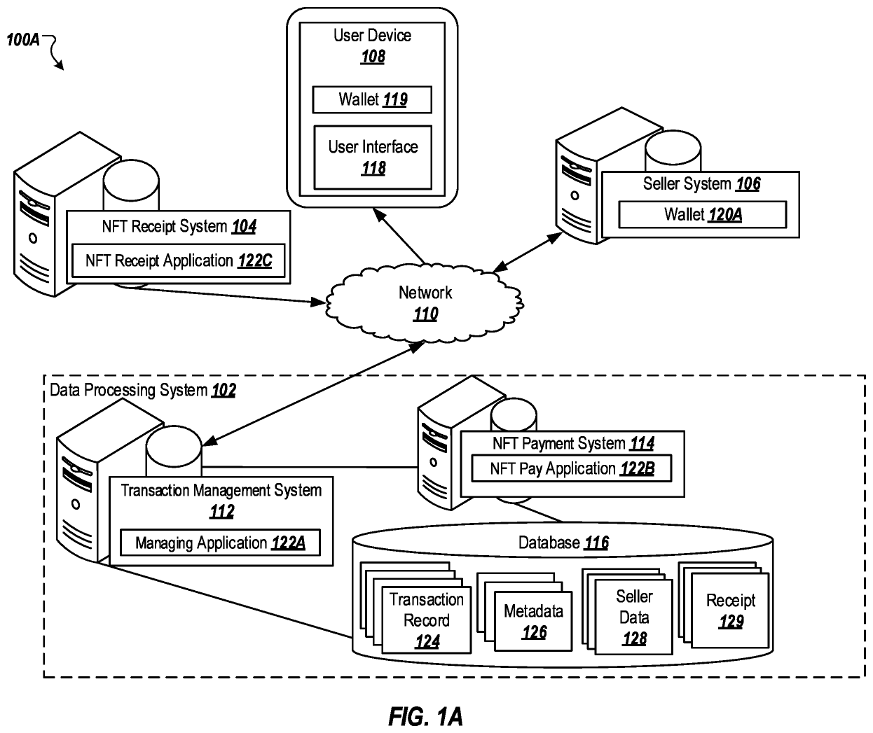

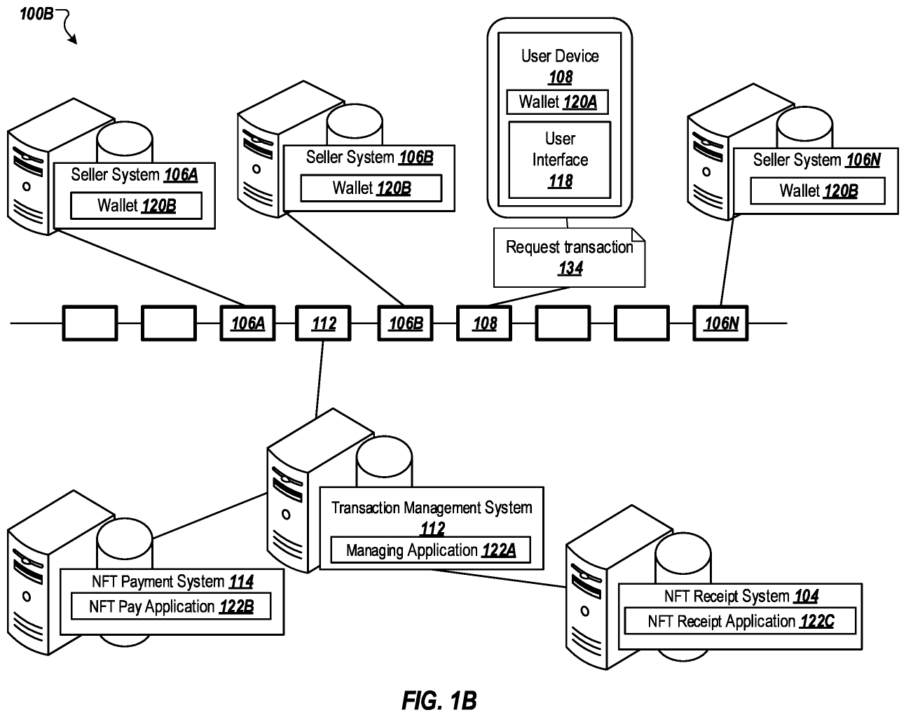

FIG. 1A depicts an example of a system 100A, in accordance with some example implementations. Referring to FIG. 1A, the example system 100A includes a NFT receipt system 104, a user device 108, a seller system 106, a data processing system 102, and a network 110.

The data processing system 102 can include any form of servers including, but not limited to a web server (e.g., cloud-based server), an application server, a proxy server, a network server, and/or a server pool. In general, the data processing system 102 includes a transaction management system 112, a NFT payment system 114, and a database 116 to manage transaction data. The transaction management system 112 is configured to manage payments performed by the NFT payment system 114 and trigger generation of receipts 129 by using the NFT receipt system 104. The transaction management system 112 and the NFT payment system 114 can be similar in terms of configuration and functions. For example, the transaction management system 112 and the NFT payment system 114 can include any form of servers including, but not limited to a web server (e.g., cloud-based server), an application server, a proxy server, a network server, and/or a server pool. In some implementations, the transaction management system 112 and the NFT payment system 114 can be included in a single server, rather than separate servers, as illustrated in FIG. 1A. In general, the transaction management system 112 and the NFT payment system 114 can include a computing device including one or more central processing units, graphical processing units, and/or the like.

In general, each receipt 129 of each transaction is represented by at least one NFT. As described below, in a typical implementation, a transaction between a buyer and a seller causes the generation of two NFTs, one representing a receipt for the buyer that is transmitted to the buyer and one representing a receipt for the seller that is transmitted to the seller.

In some implementations, the transaction management system 112 is configured to provide access to software transaction managing applications 122A. In some implementations, the NFT payment system 114 is configured to authorize software NFT payment applications 122B to generate a payment hash representing payments for transactions to buyers using user devices (e.g., the user device 108) and seller systems 106 over the network 110. In some examples, the transaction managing application 122A and the NFT payment application 122B can be any cloud-based software application. For example, the transaction management system 112 can act as a data bridge between the NFT payment system 114 and the NFT receipt system 104 for authenticated seller systems 106 and buyers using the user device(s) 108, who are authenticated in the example system 100A as entities authorized to perform transaction operations using the respective wallets 119, 120A, 120B, . . . 120N. Further, the data processing system 102 can be configured to provide access to data managed by the transaction management system 112 and/or processed by the NFT payment system 114 and stored by the database 116, over the network 110. In some implementations, the transaction management system 112 can include a wallet (e.g., that holds the delegated tokens on behalf of one or more entities, receives rewards from the blockchain network, etc.). The database 116 can include a storage component that stores data and/or software related to the processing of the data. In some implementations, the database 116 includes a cloud database system environment, an on-premise database system (e.g., system databases, tenant databases, etc.), servers (e.g., name server(s), index server(s), script server(s), etc.) or another type of system. In some implementations, the database 116 stores transaction related data including transaction records 124, metadata 126, seller data 128, and receipts 129 that are accessible (e.g., via queries, procedure calls, etc.) to the user device 108 and to the seller systems 106 over the network 110.

The NFT receipt system 104 includes any form of servers including, but not limited to a web server (e.g., cloud-based server), an application server, a proxy server, a network server, and/or a server pool. In general, the NFT receipt system 104 can include a computing device including one or more central processing units, graphical processing units, and/or the like. In some implementations, the NFT receipt system 104 is configured to provide access to software NFT receipt applications 122C for distribution of NFTs representing receipts 129 for transactions to seller systems 106 and buyers using user devices (e.g., the user device 108) over the network 110. The NFT receipt application 122C can be any cloud-based software application. The NFT receipt system 104 can process receipt orders, received from the data processing system 102 (e.g., the transaction management system 112), to generate receipts in response to payments successfully completed by the NFT payment system 114 included in the data processing system 102. The NFT receipt system 104 can transmit, for storage, receipts 129 for transactions based on transaction data retrieved by the NFT receipt system 104 to the database 116 of the data processing system 102. In some implementations, the NFT receipt system 104 can be included in the data processing system 102.

The seller system 106 can be and/or include any type of processor and memory based device, such as, for example, cellular phones, smart phones, tablet computers, laptop computers, desktop computers, workstations, personal digital assistants (PDA), network appliances, cameras, media players, navigation devices, email devices, game consoles, or an appropriate combination of any two or more of these devices or other data processing devices that can be connected to a blockchain network to run on a continuous server. In some examples, the seller system 106 includes wallet software 120A-N (e.g., blockchain wallet) or can be connected to a blockchain wallet, a node connection module for connecting the blockchain seller system 106 and the wallet 120A-N, and a node communication module for causing the wallet 120B to perform encrypted communication with the connected seller system 106. In some implementations, the wallet 120A-N includes: an address creation module, configured to create an account address in an online or offline environment; and a transaction signature module, configured to perform transaction signature in an online or an offline environment. The wallet 120A-N can be connected through the node connection module to the seller system 106 and can communicate through the node communication module to send transaction information to the seller system 106 or to obtain a wallet balance from the database 116 of the data processing system 102.

The user device 108 can be and/or include any type of processor and memory based device, such as, for example, a cellular phone, smart phone, tablet computer, laptop computer, desktop computer, workstation, navigation device, email device, game console, or an appropriate combination of any two or more of these devices or other data processing devices. The user device 108 can include a user interface 118 and a buyer wallet 119. The buyer wallet 119 can include a digital wallet, a custodial, a non-custodial, a hardware wallet, a hosted wallet, a software wallet running on the user device 108 or a remote computing system, or any other type of wallet compatible with the example system 100A. The buyer wallet 119 can hold the associated private key and funds of the user (buyer) to enable transactions between the user device 108 and the seller system 106.

The user device 108 can include a user interface 118, a processor, a memory, a storage component, a bus and any combination of fixed and variable computing components. The user interface 118 can include a user input interface, output interface, and/or a communication interface. The input interface can include a component that permits the user device 108 to receive information, such as via user input (e.g., a touchscreen display, a keyboard, a keypad, a mouse, a button, a switch, a microphone, a camera, and/or the like). Additionally or alternatively, in some embodiments input interface can include a sensor that senses information (e.g., user biometric data and/or the like). The output interface can include a component that provides output information from the user device 108 (e.g., a display, a speaker, one or more light-emitting diodes (LEDs), and/or the like).

The communication interface includes a transceiver-like component (e.g., a transceiver, a separate receiver and transmitter, and/or the like) that enables the user device 108 to communicate with other devices via a wired connection, a wireless connection, or a combination of wired and wireless connections. In some examples, the communication interface can permit the user device 108 to provide information to the data processing system 102 and/or receive information (e.g., token URIs) from the NFT receipt system 104. In some examples, the communication interface includes an Ethernet interface, an optical interface, a coaxial interface, an infrared interface, a radio frequency (RF) interface, a universal serial bus (USB) interface, a Wi-FiR interface, a cellular network interface, and/or the like. The user device 108 can include an installed wallet software buyer wallet 119 (e.g., blockchain wallet) or can be connected to a wallet software configured to perform encrypted communication with a connected seller system 106. The buyer wallet 119 includes: an address creation module, configured to create an account address in an online or offline environment; and a transaction signature module, configured to generate a transaction signature (e.g., a signature generated by using the private key associated with the sender, a private key of a signer, etc.) in an online or an offline environment. While not illustrated, in some implementations, multiple user devices 108 including different computing system configurations, such as different operating systems, different processing capabilities, different hardware components, and/or other differences can concurrently request updates regarding a transaction. For example, the user device 108 can interact with the data processing system 102 to access a transaction application (e.g., the transaction managing application 122A, the NFT pay application 122C, and/or the NFT receipt application) that enable visualization of transaction data. The user interface 118 can enable an entry of a user input including a request a transaction related to a digital asset provided by the seller system 106. The user device 108 can transmit the request for the transaction to the data processing system 102, which connects to the NFT receipt system 104 to generate a minted receipt. The user device 108 can receive, from the NFT receipt system 104, notifications including URI to the metadata regarding the payment transaction. The user interface 118 can display the notifications indicating the transfer data.

The network 110 can include one or more wired and/or wireless networks. In an example, network 110 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

The example system 100A shown in FIG. 1A, enables secure distribution of transaction data to the user device 108, and to the seller systems 106 in a privacy preserving and decentralized fashion. The process transparency can be facilitated by minting non-fungible tokens (NFT) representing receipts 129. In some examples, the NFTs are defined according to the ERC-721 standard. The transfer of assets may controlled by the transaction management system 112, configured to monitor payments performed using the NFT payment system 114 and to trigger generation of receipts 129 using the NFT receipt system 104. The transaction management system 112 can be configured to verify minting conditions and in response to determining that the conditions for an authentic mint are satisfied, the transaction management system 112 can trigger the NFT receipt system 104 to mint the NFTs representing the receipts and to transmit the links to the minted NFTs or to transmit the NFTs directly, to user and seller wallets or to an address of the user (accessible on the user device 108) and to an address of the seller (accessible on the seller systems 106) over the network 110. The configuration of the transaction management system 112 provides a computationally efficient process that can be completed with transmission of the NFT receipt within a short time interval (e.g., second to minutes) after purchase completion. The seller systems 106 of the example system 100A can benefit from an improved experience by not having to mint NFTs to buyers automatically, bypassing the challenges associated with traditional seller executed minting processes.

FIG. 1B illustrates another example blockchain network 100B, corresponding to a blockchain network implementation of the example system 100A described with reference to FIG. 1A. The example blockchain network 100B includes the transaction management system 112 (connected to the NFT payment system 114, the NFT receipt system 104), the user device 108, and node (seller) systems 106A, 106B, . . . 106N.

In some examples, the blockchain network 100B is a distributed ledger environment configured to automatically execute programs, e.g., smart contracts. In the blockchain network 100B, apart from the token being tracked by the distributed ledger on a blockchain, the blockchain network 100B also has programs that can run code associated with the transactions. The code validates conditions and, when set conditions are met, it can automatically make changes to the transaction records 124 (e.g., token records), where these changes are also tracked automatically along with the code that made the changes.

The blockchain network 100B includes multiple node systems 106A, 106B configured to replicate transaction data according to a consensus algorithm that ensures validation of new information. The blockchain network 100B may be implemented as an immutable mechanism for token issuance and transaction flow management, in which the node systems 106A, 106B involved in issuing and executing electronic token transactions may write and read data and instructions associated with one or more processes using an electronic ledger. Such a distributed ledger provides transparency of information for the permitted node systems 106A, 106B, while eliminating duplication of effort in maintaining the information due to a single source of truth replicated across multiple node systems 106A, 106B. The blockchain network 100B includes a distributed ledger design defining a blockchain system, which employs a chain of nodes 106A-106N to provide security of the information. The nodes 106A-106N are a continuously growing list of records, which are linked using cryptography (e.g., hashing) or similar data security methods. Each node 106A-106N can include a seller system, as described with reference to FIG. 1A. Each node 106A-106N can contain a cryptographic hash of a previous block to provide security, along with a timestamp and the transaction data. The node data linkage ensures that each transaction is recorded in a manner that creates an audit trail. Once recorded, the data in any given node 106A-106N cannot be altered without invalidating the cryptographic hash of all the subsequent nodes 106A-106N. The node data linkage makes the blockchain network 100B resistant to tampering of the recorded transaction data, as all copies would need to be manipulated. The blockchain network 100B may provide the infrastructure, in which the node systems 106A, 106B that manage the token transaction process may communicate by writing to block addresses designated to the node systems 106A, 106B engaged in the process.

As shown, the example blockchain network 100B includes multiple linked data blocks including the node systems 106A, 106B. The blockchain network 100B may be communicatively connected or coupled to the NFT receipt system 104 and data processing system 102 configured to respectively issue and execute one or more digital tokens, such as a transaction record 124 associated to a non-fungible token of a digital asset (e.g., digital currency and digital legal currency, central bank issued digital currency, vouchers and value substitutes, or debts to issuer debts). A user may interact with the NFT receipt system 104, by way of a user interface mechanism for example, to request a transaction 134. The process model for the blockchain network 100B may define parameters and constraints associated with the manner in which token data is to be utilized or manipulated. For example, in some implementations, the rules for managing the request for transaction 134 can include: a token to be recorded on the blockchain network 100B, the token to be freely transferred on the blockchain network 100B subject to smart contracts complying with approved consent conditions, tokens to be stored or redeemed either on the blockchain network 100B or in another system (e.g., an event provider's point of sale system). The process for managing requested tokens may be implemented by enabling one or more node systems 106A, 106B of the blockchain network 100B to execute token transfer operations with respect to one or more records in the blockchain network 100B. The indication received as authorized by a first entity (e.g., a seller of the token and/or the digital asset associated with the token) allows for the exchange of the first token with the second token.

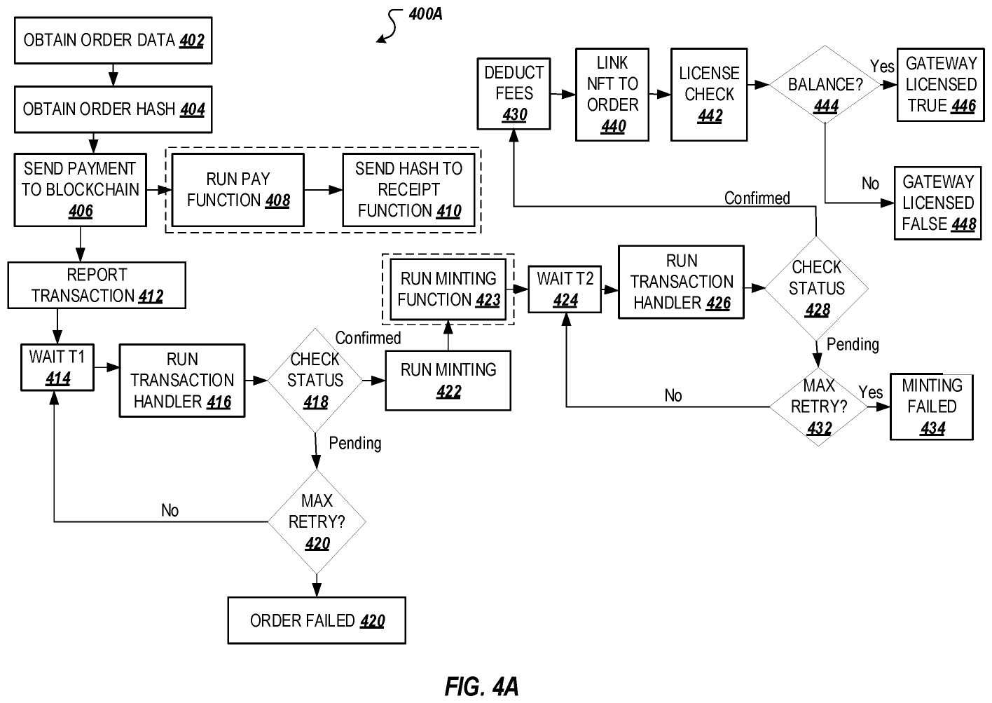

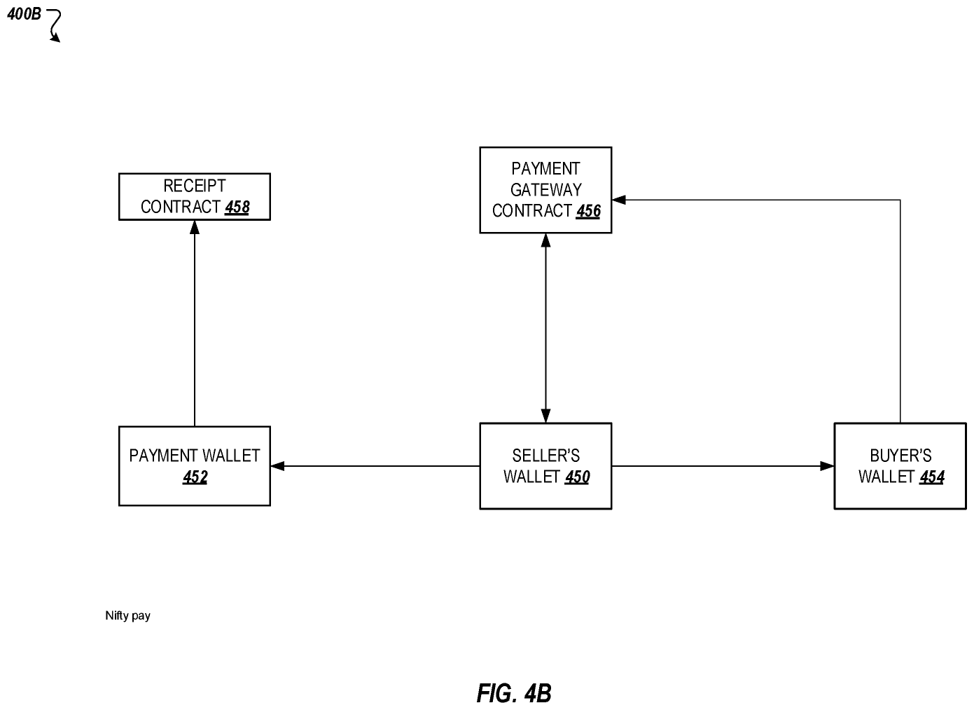

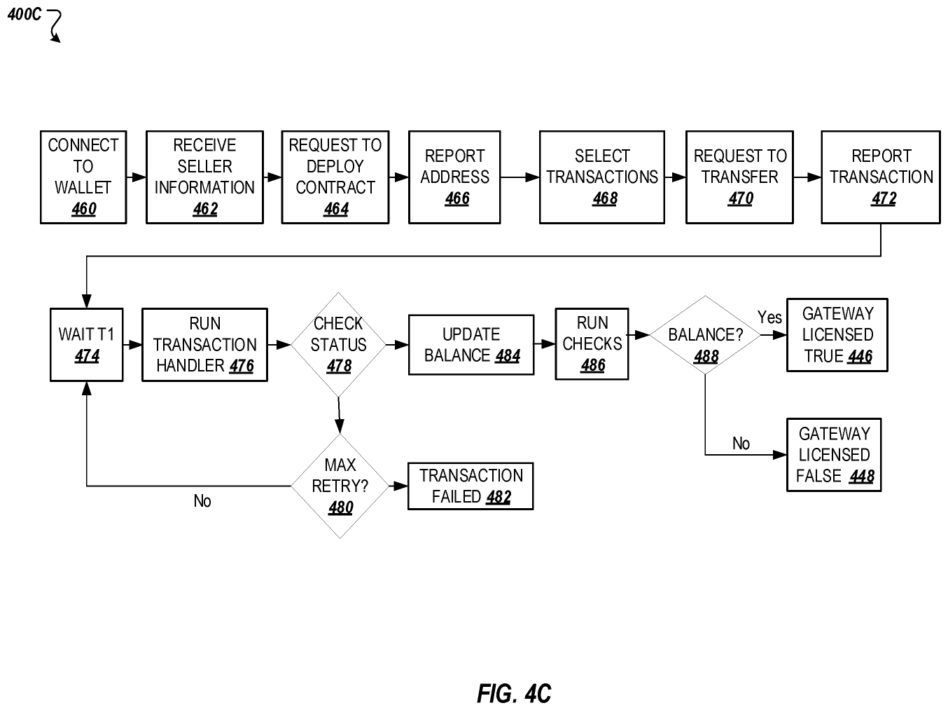

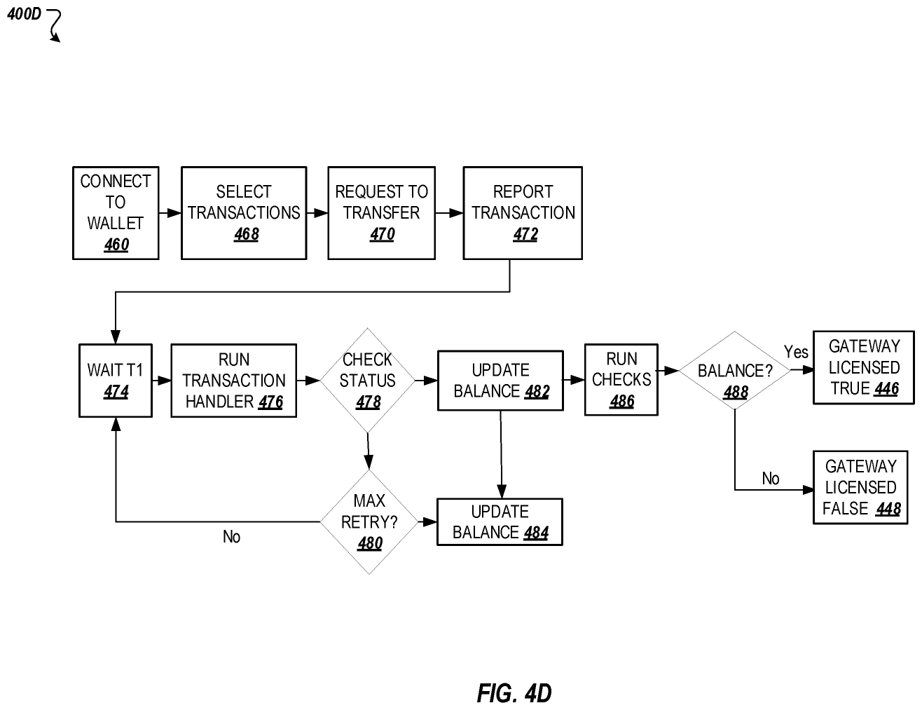

The first token, in some aspects, is associated with ownership information that indicates the first token is owned by the first entity. The first token may also include additional information (e.g., data or metadata), corresponding to the transaction record 124. The ownership of the first token can be transferable to other entities (e.g., buyers or resellers) over the electronic ledger environment according to the ownership information associated with the first token as provided in further detail below. Each token or batch of tokens can be mapped to an (encrypted or not encrypted) email address of the seller system 106A-106N to enable transmission of token transfer data to the user device 108 of the buyer. The user device 108 of the buyer can transmit, to the NFT payment system 114, an address of the buyer wallet 119 to generate a receipt of the minted transactions. The transaction minting service can be performed by the NFT receipt system 104, according to the example process 400A as described in detail with reference to FIG. 4A.

In some implementations, the blockchain network 100B, in response to the transaction management system 112 receiving an indication that the buyer using the user device 108 visits the payment link generated by NFT payment system 114, generates a transaction hash that is reported over the NFT pay application 122B and attached to the transaction charge to be saved in the transaction record 124. The transaction management system 112 can control the NFT pay application 122B to verify payment for a respective transaction by monitoring (at a set frequency during a set period of time) that the transaction until payment is confirmed or the payment fails. If confirmed, NFTs are minted by the transaction management system 112 (e.g., the managing application 122A backend) and transmitted to the buyer using the user device 108 and seller system 106A-106N. The fee account balance can be deducted by the cost of minting the two NFTs. The transaction management system 112 can update the transaction records 124, depending on the balance of the fee account (positive or negative). The license status of a given payment gateway address can be stored in the receipt contract. The minting wallets can toggle the license status of the gateway address in the receipt contract, if the minting of NFT(s) causes the sellers balance of the fee account to become negative. The payment gateways license status license status can be configured by minting wallets interacting with the shared NFT receipt. The transaction management system 112 can continuously monitor the minting transactions to make sure that the transactions complete. If the transactions fail for some reason, the transactions can be marked as failed in the backend and an attempt for re-execution of the transactions can be performed at a later time (according to a set time condition). If the transactions are confirmed, the NFT token identifiers are attached, by the transaction management system 112, to the charge object (e.g., a collection of metadata associated with a request for payment).

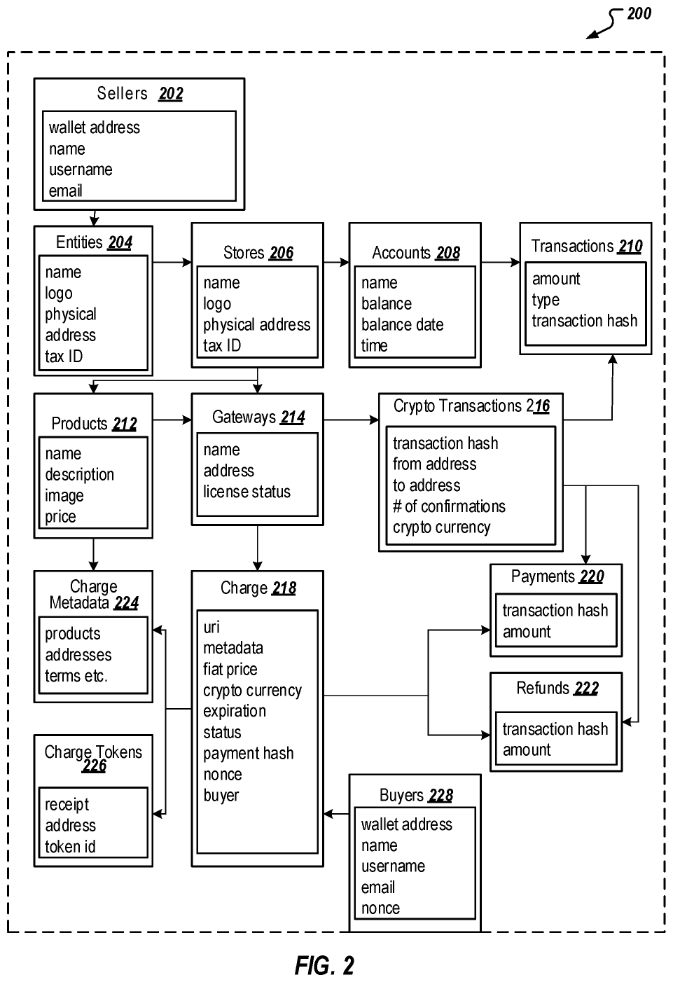

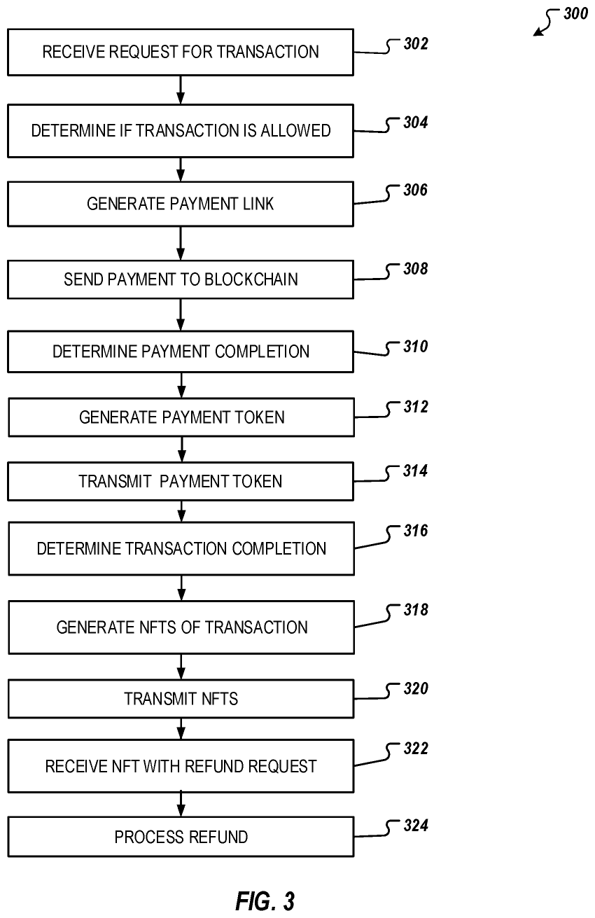

Without limitation and by way of example, in some embodiments, the generation of the token may be stored in one or more database records of a data processing system 102, or records in an electronic ledger environment 100 (e.g., an electronic ledger platform), in accordance with a one or more protocols, such as database 116, as described in detail with reference to FIG. 2. The protocols can control and memorialize the downstream exchange of the tokens and the related transactions among multiple node systems 106A, 106B, via the blockchain system 100B, and are configured to commit the tokenized transactions including at least a blockchain seller system 106, the user device 108, and/or the transaction management system 112. The tokenized transactions are described in further detail with reference to FIGS. 3 and 4.

FIG. 2 depicts a diagram of an example database 200, in accordance with some example implementations. The example database 200 can be accessed by a transaction management system, a NFT payment system, or a NFT receipt system, or any other component of a system controlling transactions between sellers and buyers, as described with reference to FIGS. 1A and 1B. The example database 200 can be included in the database 116, described with reference to FIGS. 1A and 1B.

The example database 200 can be configured to provide access to seller data 202, entity data 204, store data 206, account data 208, transaction data 210, products 212, payment gateway data 214, crypto transactions 216, charge data 218, payments 220, refunds 222, charge metadata 224, charge tokens 226, buyer data 228, and other data. The seller data 202 can include a wallet address, a name, a username, an email address and other contact information and/or identifiers (e.g., integers). The entity data 204 can include a name, a logo, a physical address, a tax identifier (ID) and other general information and a verification status. The store data 206 can include a name, a logo, a physical address, a tax identifier (ID) and other descriptive information and/or identifiers (e.g., integers). The account data 208 can include a name, a balance date, a time. The transaction data 210 can include an amount, a type, a transaction hash, point of sale carts, invoices, peer to peer transactions, and other transaction data associated with a transaction type. The products 212 can include a name, a description, an image, SKU, an inventory, and a price per product. The payment gateway data 214 can include a name, an address, a license status (e.g., Boolean) and other descriptive information and/or identifiers (e.g., integers). The crypto transactions 216 can include a transaction hash, a sender address, a receiver address, a number of confirmations, and/or an amount (e.g., text or numerical value) of a cryptocurrency of a particular cryptocurrency type. The charge data 218 can include URIs, metadata, a flat price, a cryptocurrency, an expiration, a status, a payment hash, a nonce (e.g., a variable character), a buyer identifier (e.g., an integer) and other charge information/identifiers (e.g., integers). The payments 220 can include a transaction hash for each transaction, an amount per transaction and other transaction information/identifiers (e.g., integers). The refunds 222 can include a transaction hash for each refund, an amount per refund and other refund information/identifiers (e.g., integers). The charge metadata 224 can include products, addresses, and terms. The charge tokens 226 can be NFTs that represent tokens associated with charges for effectuated (successfully completed) transactions. The charge tokens 226 can include receipts 129, addresses, and token IDs. The buyer data 228 can include a wallet address, a name, a username, an email address, a nonce, and other contact information and/or identifiers (e.g., integers). The other data can include receipt NFT metadata (e.g., parties, currencies, amounts and pictures), user settings (e.g., connecting an email to a blockchain address, notification preferences, etc.), invoice data (e.g., items, terms, etc.), fee account information (e.g., NFTs minted, recharge transactions), cached cryptocurrency (Ethereum) transaction information, cached receipt NFT information. In some implementations, each data type stored in the example database 200 (e.g., seller data 202, entity data 204, store data 206, account data 208, transaction data 210, products 212, payment gateway data 214, crypto transactions 216, charge data 218, payments 220, refunds 222, charge metadata 224, charge tokens 226, buyer data 228) can include a time stamp indicating the time when the data was stored or updated.

As illustrated in FIG. 2, in some implementations, the seller data 202 (e.g., wallet address, name, username, email) is linked to (updated simultaneous or in conjunction with) entity data 204 (e.g., name, logo, physical address, tax ID). The entity data 204 can be linked to store data 206 (e.g., name, logo, physical address, tax ID). The store data 206 can be linked to account data 208 (e.g., name, balance, balance date, time), payment gateway data 214 (e.g., name, address, license status), and products 212 (e.g., name, description, image, price). The payment gateway data 214 can be linked to crypto transactions 216 (e.g., transaction hash from address to address, number of confirmations, crypto currency) and charge data 218 (e.g., URI, metadata, flat price, crypto currency, expiration status, payment hash, nonce, buyer). The crypto transactions 216 can be linked to transaction data 210 (e.g., amount, type, transaction hash), payments 220 (e.g., amount, transaction hash), and refunds 222 (e.g., amount, transaction hash). The charge data 218 can be linked to charge metadata 224 (e.g., products, addresses, terms), charge tokens 226 (e.g., receipt, address, token ID), buyer data 228 (e.g., wallet address, name, username, email), payments 220, and refunds 222. For example, the payment data for charges can connect blockchain transactions with charges. In some implementations, in response to updating a data type associated with a transaction can trigger an update of the linked data types, the trigger including the transaction identifier, a currency identifier, a payment gateway identifier, a seller token identifier, and/or a buyer token identifier. The processes related to data updates in the example database 200, are described with reference to FIGS. 3 and 4A-4D.

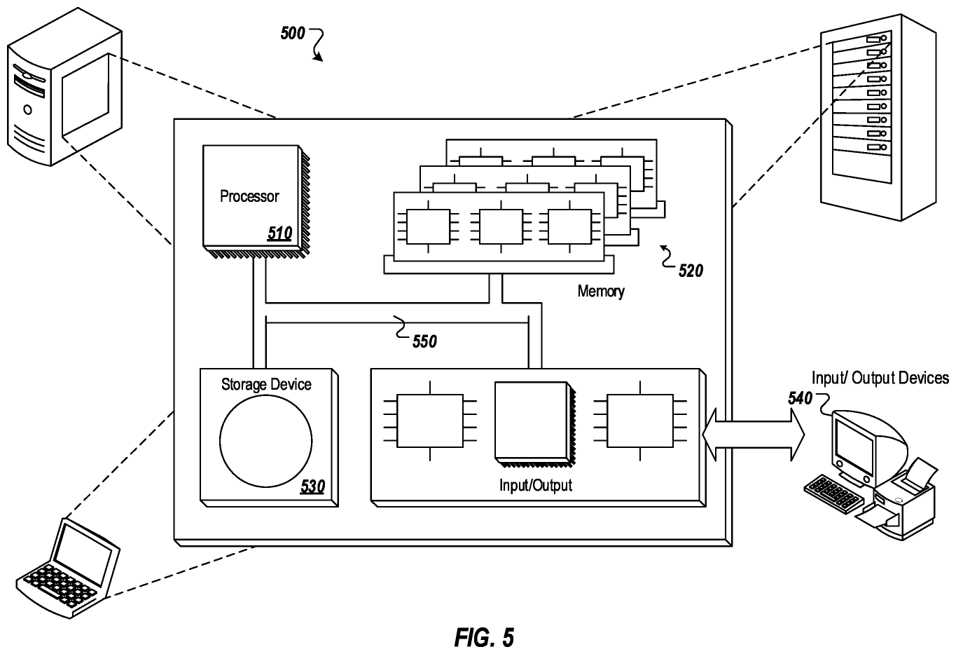

FIG. 3 depicts a flowchart illustrating an example process 300 for managing distribution of NFTs representing receipts 129 for blockchain transactions, in accordance with some example implementations. The process 300 can be executed by the example system 100A shown in FIG. 1A, the blockchain network 100B shown in FIG. 1B, and/or the system 500 shown in FIG. 5 or any combination thereof. The process 300 can be executed by using the example database 200 shown in FIG. 2.

At 302, a request for a transaction over a blockchain network is received, by a computing device. For example, the request is received, by a blockchain node (e.g., transaction management system 112 or a node system 106A-106N described with reference to FIGS. 1A and 1B) of a blockchain network (e.g., blockchain network 100B) and from a buyer using a user device (e.g., user device 108 described with reference to FIGS. 1A and 1B) that can be registered as a node system of the blockchain network. The requested transaction can include a transfer of assets (products of a particular type and a particular amount provided for transactions by a particular seller) between a target node (e.g., seller system 106, 106A-N described with reference to FIGS. 1A and 1B) to a recipient node (e.g., buyer, such as the user device 108 described with reference to FIGS. 1A and 1B). The target node (e.g., seller) and the recipient node (e.g., buyer) can be included in a blockchain network, being registered users of the blockchain network and having registration files that can include seller data and buyer data, respectively, that can be stored in a database (e.g., example database 116 described with reference to FIG. 1A or example database 200 described with reference to FIG. 2). In some implementations, the transaction request can be generated in response to receiving a user input indicating a selection from multiple browsed products displayed by a user interface displaying electronic commerce (ecommerce) stores or marketplaces including assets (e.g., digital and/or physical assets, such as products of a particular type and a particular amount provided for transactions by a particular seller) available for transactions that are provided by seller(s). The buyer can access the ecommerce stores or marketplaces to query for available datasets (e.g., determine which data sets are available via the decentralized node network). The marketplace can return results of available data/asset types that can depend on a buyer authorization level, a seller authorization, and or search criteria. In some implementations, the results are filtered by a machine learning system configured to increase an efficiency of asset selection from the assets available on the marketplace.

At 304, it is determined whether the transaction is allowed (authorized) by performing checks regarding the currency and destination requested to perform the transaction. In some implementations, determining that the transaction is authorized can include determining that the target node (e.g., seller) is identified (e.g., verify a map of addresses that are allowed to mint the NFTs that can be associated with the seller data, such as seller data 128 described with reference to FIG. 1A that is stored in the database 116) as an entity allowed to perform the second (subsequent) transaction operation (e.g., transfer of a digital asset). In some implementations, determining that the transaction is authorized can include performance of checks regarding the currency and destination selected by the recipient node (e.g., buyer).

At 306, a link (e.g., payment link) to a first transaction operation (e.g., payment) is generated for the recipient node (e.g., buyer) using payment gateway data (e.g., payment gateway data 214 described with reference to FIG. 2) and product data (e.g., product data 212 payment gateways 214) corresponding to the asset(s) identified in the requested transaction. For example, for sellers with existing ecommerce stores and physical stores with point of sale systems, a JavaScript widget can be provided to be embed into the seller store. The widget can allow the seller system to generate charges within their own checkout workflows. In some implementations, seller system can create invoices that are accessible using the payment link. In some implementations, seller system can use an application programming interface (API) of the transaction management system to create charges accessible using the payment link. In some implementations, seller system can use a payment gateway contract to create a singular payment request, much like Venmo or Paypal that can be useful for infrequently selling items, such as a handmade good store or classified item sales.

At 308, the payment link is transmitted to the recipient node (e.g., buyer). In some implementations, the payment link is transmitted (e.g., as a push notification, as an email, as a text message, or by using any other transmission protocol) to a user device of the buyer to be displayed by a user interface displaying an application associated with the transaction and/or to an (email or message) inbox of the buyer. For example, the payment link can be configured to enable the user device to access a NFT pay application of a NFT payment system (e.g., NFT payment system 114 described with reference to FIGS. 1A and 1B).

At 310, a first result of the first transaction operation (e.g., payment) is received from the recipient node (e.g., buyer). The first result can be processed to verify whether payment completion was successful. Buyers can pay the contract in the blockchain's native currency or by using any ERC20 token, as long as the currency is enabled by both the gateway contract and the connected receipt contract and the gateway contract is configured in the receipt contract. The receipt contract can be an ERC-721 NFT contract with customizations. Verification of payment completion can include a verification of multiple operations including verification of a balance account, verification of access of the payment link, verification of fund transfer, and/or verification of a match between the transferred funds (during payment) and a charged amount relative to the balance account. The verification of payment completion can be performed by the transaction management system (e.g., transaction management system 112 described with reference to FIGS. 1A and 1B) that can communicate with the payment system and/or can monitor payments to the payment gateway contract for a set period of time with a set frequency. If the payment completion fails for any reason, the first transaction operation (e.g., payment) is marked as failed, by the transaction management system, and can be retried for a set number of times until successful or until a repetition threshold is met that can trigger termination of the example process 300.

At 312, in response to determining that the first transaction operation (e.g., payment) was successful, a first token (distributable voucher that is redeemable for particular goods or services) of the first result of the first transaction operation (e.g., a payment token) is generated. The first token can include a payment hash created by passing an integer nonce, string URI, buyer address, and seller address into the ‘generateCommitment’ function of the receipt contract. The first token can trigger a second transaction operation (e.g., transfer). The second transaction operation (e.g., transfer) can include a shipment of at least one of the selected assets (e.g., cryptocurrencies, images, data, or any digital item transferrable via a blockchain network).

At 314, the first token is transmitted, over the blockchain network, from the payment gateway contract of the NFT payment system (e.g., NFT payment system 114 described with reference to FIGS. 1A and 1B) to the receipt contract of the NFT receipt system (e.g., NFT receipt system 104 described with reference to FIGS. 1A and 1B). The first token can be transmitted using a commit/reveal minting strategy. In some implementations the transfer of the first token includes a release of the respective token escrow, which is determined by the NFT receipt system, the node system, external APIs, and/or other oracle sources. In some implementations the transfer of the first token can be based on a smart contract transaction performed on the blockchain network, as described with reference to FIG. 4A.

At 316, a second result of a second transaction operation (e.g., transfer) is received by the transaction management system from the recipient node (e.g., buyer system) and the target node (e.g., seller system). The second result of the second transaction operation can include a confirmation that the selected digital assets were sent, by the target node (e.g., seller system), to and received by the recipient node (e.g., buyer system, such as the user device). The confirmation can include a match between the digital assets selected by the recipient node (e.g., buyer) for the transaction and the received digital assets, including a match between digital asset types and amounts.

At 318, in response to determining that the second transaction operation (e.g., transfer) is completed, a pair of NFTs with a respective pair of token uniform resource identifier (URI) is generated. The token URIs within a pair can include an identical portion and a unique portion defining the charge token numbers that can be added as a suffix, having a format like: https://<baseurl>/<chargeidentifier>/<tokenNumber>. The token URIs can point to a URL to retrieve (encrypted or not encrypted, or using a partial encryption protocol depending on the data sensitivity and/or security level) metadata associated with the transaction including the second result of the second transaction operation. For example, each non-fungible token of the pair of non-fungible tokens can include contact information (e.g., logo, email addresses, physical addresses) of the involved entities (the target node and the recipient node) and asset transaction information. A single NFT is automatically minted to each of the recipient node (e.g., buyer) and the target node (e.g., seller), per transaction. Minting can be performed by using a list of allowed minter addresses (included in the receipt contract) that can mint NFTs on behalf of the buyer and seller after the commitment age passed. The minting process can include a rotation through minting wallets as a security best practice. In some implementations, the generation of the pair of NFTs can depend on a verification of one or more conditions related to transaction parameters including a minimum time period from completion of transaction. In some implementations, the generation of the pair of NFTs is queued in a chain of transactions. The chain of transactions can be rearranged based on a history and priority of transactions. For example, higher gas transactions and previously queued transactions that reuse the same nonce can be given a higher priority. The reuse of the same nonce is applicable to cases when a transaction has been taking too long to confirm and the transaction is resubmitted with the same nonce.

At 320, one of the NFTs is transmitted to the recipient node (e.g., buyer system) and the second one of the NFTs is transmitted to the target node (e.g., seller system), respectively. The transfer information can be transmitted to the buyer sending funds portal, to be displayed as notifications, by the user interface of the user device, as described with reference to FIG. 2. For example, the information pertaining to the use and data characterization of the token can be relayed to the buyer sending funds being an authenticated user of the user device, via the managing application (e.g., managing application 122A described with reference to FIGS. 1A and 1B).

At 322, an NFT is received from the recipient node (e.g., buyer system) with a refund request, the NFT identifying a past (completed) transaction associated with stored charge tokens (e.g., charge tokens 226 described with reference to FIG. 2). At 324, the NFT is used to process the refund. Refunds for payments can include connection to blockchain transactions with payment refunds and processing receipt NFT metadata (e.g., entity identifiers, currencies, amounts and pictures). In some implementations, refund processing can be limited to a set time period after the completion of the transaction, such that any refunds requested beyond the set time period can be denied.

The example process 300 enables a computationally efficient distribution of transaction data to participants in a blockchain network. Using the example process 300, the example systems can enable secure distribution of NFTs to participants in a privacy preserving and decentralized fashion. The secure distribution of sensitive data is implemented in the example process 300 using a NFT minting process that prevents front running, without the buyer being charged. The described example process 300 enables sellers to own their contracts and access associated transactions at all times. The example process 300 enables any number of addresses to be designated as minter addresses. The described example process 300 can be executed by a blockchain-based system that can maintain a massive scale and throughput in minting NFTs, which the example process 300 prioritizes to increase the efficiency of the throughput.

FIGS. 4A-4D illustrate depict examples of portions of the process described with reference to FIG. 3. FIG. 4A shows a flowchart illustrating an example process 400A for payment and minting during blockchain transactions, in accordance with some example implementations. The process 400A can be executed by the example system 100A shown in FIG. 1A, the blockchain network 100B shown in FIG. 1B, and/or the system 500 shown in FIG. 5 or any combination thereof. The process 400A can be executed by using the example database 200 shown in FIG. 2.

At 402, order data is obtained from a transaction order source including a point of sale, a new invoice, a pay button, a peer to peer. At 404, an order hash corresponding to the order data is obtained. The order hash can be generated by calling a “generateCommitment” function corresponding to a receipt contract of a receipt application. The order hash can include an encoded string of information about the order. The process 400A can be configured to reveal the “nonce” only to the buyer and the transaction management application, which keeps the order hash secret until the NFT is minted. The limited nonce disclosure can help prevent front running of the mint transaction. At 406, a payment is sent to the blockchain. At 408, a pay function is executed. Following is provided an example of a pay function execution.

```
  /// @notice Main function of the contract which allows the user to pay for a
given payment hash
  /// @param _currency Currency being paid in
  /// @param _amount Amount being paid
  /// @param _hash Hash of the payment
  /// @dev Sending the hash in this function which encodes data about the
payment with the sender of the txn enables the commit/reveal strategy used in the PayReceipt
contract
  function pay(
    address _currency,
    uint256 _amount,
    bytes32 _hash
  )
    external
    payable
    whenNotPaused
    nonReentrant
  {
    // Load receipt contract
    PayReceipt _receiptContract = PayReceipt(nftAddress);
    require(_receiptContract.currencyAddressSupported(_currency), “Currency
not supported by receipt contract”);
    require(currencyAddressSupported[_currency], “Currency not supported by
gateway contract”);
    require(_amount >=
_receiptContract.currencyMinimumAmount(_currency), “Amount is less than minimum
required”);
    // Make sure the proper amount was sent
    // Native
    if (_currency == address(0)) {
    require(msg.value > =_amount, “Native amount was less than expected”);
    // ERC20
    } else {
    // Some ERC20 tokens have transfer fees, make sure the correct amount
after fees was deposited
    IERC20 token = IERC20(_currency);
    uint256 balanceBefore = token.balanceOf(address(this));
    token.safeTransferFrom(msg.sender, address(this), _amount);
    uint256 balanceAfter = token.balanceOf(address(this));
    require(balanceBefore + _amount >= balanceAfter, “ERC20 amount was
less than expected”);
    }
    // Make the commitment on the receipt contract
    PayReceipt(nftAddress).commit(_hash);
    emit Pay(msg.sender, _hash, _currency, _amount);
    }
```

As shown in the provided example, the pay function execution can call a function to determine whether a currency is supported, such as indicated in the following example.

```
  /// @notice Store if a given currency is supported
  mapping(address => bool) public currency AddressSupported;
  ...
  /// @notice Allow toggling of support for a given currency to prevent
unwanted payments
  /// @param _currency Address of the currency to set support for
  /// @param _supported Currency supported flag
  function setCurrencyAddressSupported(
    address _currency,
    bool _supported
  )
    external
    onlyOwner
  {
    currency AddressSupported[_currency] = _supported;
    emit Currency AddressSupportedSet(msg.sender, _currency,
    _supported);
  }
```

At 410, a hash generated by the pay function is sent to the receipt function. At 412, the payment result for the transaction is reported. At 414, a delay corresponding to a set first time interval T1 is being added. At 416, the transaction handler job is executed. At 418, a status of the transaction is checked to verify validity of transaction. At 420, if one or more transaction parameters is not satisfied it is determined whether a maximum number of retries to validate the transaction is reached. In response to determining that a maximum number of retries to validate the transaction is not reached, the process 400A can return to waiting a set first period of time T1. In response to determining that a maximum number of retries to validate the transaction is reached, at 420, it is determined that the order failed. If the status of the transaction is confirmed, at 422, the minting process is executed.

At 423, a minting function of a receipt contract application is executed to mint NFT to buyer and seller wallets. The receipt contract can be owned and controlled by the NFT payment system (e.g., NFT payment system 114 described with reference to FIGS. 1A and 1B). The receipt application can be configured according to a receipt contract that can be controlled by a transaction managing system. The minting can be executed for entities included in a list of “minter addresses” that are authorized, by the transaction managing system, to call the minting function of the receipt application. At 424, a delay corresponding to a set second time interval T2 is being added to wait a set time interval for minting to be completed. At 426, a mint transaction handler job is executed to determine a status of the transaction minting. At 428, the status of the transaction is checked to verify validity of minting.

At 430, if all minting parameters are satisfied, NFT links (e.g., URIs) are generated. At 432, if one or more minting parameters are not satisfied, it is determined whether a maximum number of retries to validate the minting is reached. In response to determining that a maximum number of retries to validate the minting is not reached, the process 400A can return to waiting a set second period of time T2. In response to determining that a maximum number of retries to validate the minting is reached, at 434, it is determined that the minting failed. If the status of the minting transaction is confirmed, at 422, the NFTs are linked to the charge in the database.

At 430, gas fees are deducted from seller account and, optionally, the buyer account. The gas fees can be deducted if the minting was successful or the transaction failed and gas was consumed. The fee account balance is deducted by the cost of minting the two NFTs. At 440, NFTs are linked to the order. At 442, a status of the gateway license is checked by verifying the gateway license validity. At 444, if the gateway license is valid, it is determined whether a fee account balance is positive. Depending on the balance of the fee account (positive or negative) the payment gateway contract is updated to reflect the license status of the receipt gateway. In response to determining that the fee account balance is positive, at 446 the status of the receipt gateway is set to be true, for a subsequent transaction to be allowed. In response to determining that the fee account balance is negative, at 448, the status of the receipt gateway is set to be false and subsequent transactions are blocked until the balance is adjusted and the license status is set to true.

The example process 400A can be executed to provide the NFT minting service as quickly as possible upon a buyer making payment to a seller. For example, a buyer can visit a payment link generated by one of the charge workflows of the example process 400A. In response to determining that payment is successfully completed, the transaction hash can be reported over the API and can be attached to the charge. The transaction managing system can continuously monitor the transaction until it fails or is confirmed. If confirmed, NFTs can be minted by the transaction managing application backend to the buyer and seller. The transaction managing system can continuously monitor the minting transactions to make sure they complete. If they fail for some reason, they are marked as failed in the backend and can be retried later. If they are confirmed, the NFT tokenIds are attached to the charge object.

FIG. 4B shows a flowchart illustrating an example process 400A for movement of funds during blockchain transactions, in accordance with some example implementations. The process 400B can be executed by the example system 100A shown in FIG. 1A, the blockchain network 100B shown in FIG. 1B, and/or the system 500 shown in FIG. 5 or any combination thereof. The process 400B can be executed by using a seller's wallet 450, a payment wallet 452, a buyer's wallet 454, the payment gateway contract 456, and the receipt contract 458.

The seller's wallet 450 (e.g., wallet 120A, 120B, . . . , 120N described with reference to FIGS. 1A and 1B) hosted by the seller system (e.g., seller system 106 described with reference to FIGS. 1A and 1B) is accessed to activate operations to pay gas fees. For example, the seller's wallet can send gas fees and stable coins to prepay transaction fees to the payment wallet 452 of the transaction management system (e.g., transaction management system 106 described with reference to FIGS. 1A and 1B). The payment wallet 452 of the transaction management system can verify the received fees, can pay gas fees for minting (deduct from seller fee account), can license the payment gateway(s), and can generate configurations according to the NFT receipt contract 458. As another example, the seller's wallet 450 can pay gas fees and other digital assets (e.g., cryptocurrency) for verified and approved refunds to the buyer's wallet 454 (e.g., wallet 119 described with reference to FIGS. 1A and 1B) hosted by the seller system (e.g., user device 108 described with reference to FIGS. 1A and 1B). The buyer's wallet 454 can pay gas fees and other digital assets (e.g., cryptocurrency) for verified and approved orders to the payment gateway contract 456. The seller can initiate a transaction to withdraw funds collected by the payment gateway contract 456. As another example, the seller's wallet 450 can send gas fees with transactions for deployment, for withdrawing funds and for other configurations to the payment gateway contract 456. In some implementations, the fund withdrawal is executed using a function as indicated in the following example.

```
/// @notice Withdraw balance for the sender for a given currency
/// @param _currency Address of the currency to withdraw balance for
function withdraw(
  address _currency
)
  external
  whenNotPaused
  nonReentrant
  onlyOwner
{
  _handleWithdrawal(_currency, msg.sender);
}
```

FIG. 4C shows a flowchart illustrating an example process 400C for payment gateway deployment during blockchain transactions (e.g., recharging a fee account during onboarding), in accordance with some example implementations. The process 400C can be executed by the example system 100A shown in FIG. 1A, the blockchain network 100B shown in FIG. 1B, and/or the system 500 shown in FIG. 5 or any combination thereof.

At 460, a seller can access a transaction management application and connect the seller's wallet. At 462, seller information (e.g., inventory of available digital assets for sale with respective prices), is received to be added or modified in an ecommerce system or marketplace. At 464, the seller is prompted in wallet to deploy a payment. At 466, on confirmation, the payment gateway address is reported over the API. At 468, the seller can choose a set number of transactions to prepay for. At 470, the seller is prompted to transfer stables to the transaction management wallet. At 472, transactions are reported over the API. At 474, a waiting time interval is selected. At 476, a fee account transaction handler is executed. At 478, a status of the transaction is verified. At 480, if one or more transaction parameters are not satisfied, it is determined whether a maximum number of retries to validate the transaction is reached. In response to determining that a maximum number of retries to validate the transaction is not reached, the process 400C can return to waiting the set period of time. In response to determining that a maximum number of retries to validate the transaction is reached, at 482, it is determined that the transaction failed. If the status of the transaction is confirmed, at 484, the fee account transaction is recorded to update the balance. At 486, payment gateway license is checked by verifying the fee account balance. At 488, it is determined whether a fee account balance is positive. Then, depending on the balance of the fee account (positive or negative) the payment gateway contract is updated to reflect the license status of the receipt gateway. In response to determining that the fee account balance is positive, at 446 the status of the payment receipt gateway is set to be true and a subsequent transaction can be allowed. In response to determining that the fee account balance is negative, at 448, the status of the payment receipt gateway is set to be false and the transaction is blocked.

In some implementations, during the onboarding process, the buyer is prompted to name their payment gateway contract, which is recorded to the database. The frontend can generate a transaction to deploy the payment gateway contract using an audited bytecode, passing in the current receipt contract address to the payment gateway contract constructor. The seller can be prompted by their wallet application to approve the transaction using the example process 400C. After the transaction is submitted, the transaction monitoring system can monitor the blockchain for confirmation. In response to receiving a confirmation, the contract address can be recorded to the database.

FIG. 4D shows a flowchart illustrating an example process 400D for managing fee accounts during blockchain transactions (e.g., recharging a fee account after onboarding), in accordance with some example implementations. The process 400D can be executed by the example system 100A shown in FIG. 1A, the blockchain network 100B shown in FIG. 1B, and/or the system 500 shown in FIG. 5 or any combination thereof.

At 460, a seller can access a transaction management application and connect the seller's wallet. At 468, the seller can choose a set number of transactions to prepay for. At 470, the seller is prompted to transfer stables to the transaction management wallet. At 472, transactions are reported over the API. At 474, a waiting time interval is selected. At 476, a fee account transaction handler is executed. At 478, a status of the transaction is verified. At 480, if one or more transaction parameters are not satisfied, it is determined whether a maximum number of retries to validate the transaction is reached. In response to determining that a maximum number of retries to validate the transaction is not reached, the process 400C can return to waiting the set period of time. In response to determining that a maximum number of retries to validate the transaction is reached, at 482, it is determined that the transaction failed. If the status of the transaction is confirmed, at 484, the fee account transaction is recorded to update the balance. At 486, payment gateway license is checked by verifying the fee account balance. At 488, it is determined whether a fee account balance is positive. Then, depending on the balance of the fee account (positive or negative) the payment gateway contract is updated to reflect the license status of the receipt gateway. In response to determining that the fee account balance is positive, at 446 the status of the payment receipt gateway is set to be true and a subsequent transaction is allowed. In response to determining that the fee account balance is negative, at 448, the status of the payment receipt gateway is set to be false and the transaction is blocked.

In some implementations, entities can have any number of fee accounts, which hold a balance. Each time the transaction managing system mints an NFT, the payment fee is deducted from the fee account linked to the payment gateway. To initialize the fee account, the seller selects how many transactions they would like to prepay for, as shown in the example process 400D. The seller systems can be prompted in the wallet to approve a transaction to send stable coins to a transaction managing wallet. The transaction hash can be reported to the transaction managing system, which is monitored for confirmation. Once confirmed, the database can be updated with the initial fee account balance and the payment gateway contract can be marked as “licensed” in the receipt contract.

In some implementations, the current subject matter can be configured to be implemented in a system 500, as shown in FIG. 5. The system 500 can include a processor 510, a memory 520, a storage device 530, and an input/output device 540. Each of the components 510, 520, 530 and 540 can be interconnected using a system bus 550. The processor 510 can be configured to process instructions for execution within the system 500. In some implementations, the processor 510 can be a single-threaded processor. In alternate implementations, the processor 510 can be a multi-threaded processor. The processor 510 can be further configured to process instructions stored in the memory 520 or on the storage device 530, including receiving or sending information through the input/output device 540. The memory 520 can store information within the system 500. In some implementations, the memory 520 can be a computer-readable medium. In alternate implementations, the memory 520 can be a volatile memory unit. In yet some implementations, the memory 520 can be a non-volatile memory unit. The storage device 530 can be capable of providing mass storage for the system 500. In some implementations, the storage device 530 can be a computer-readable medium. In alternate implementations, the storage device 530 can be a floppy disk device, a hard disk device, an optical disk device, a tape device, non-volatile solid state memory, or any other type of storage device. The input/output device 540 can be configured to provide input/output operations for the system 500. In some implementations, the input/output device 540 can include a keyboard and/or pointing device. In alternate implementations, the input/output device 540 can include a display unit for displaying graphical user interfaces.

In some implementations, one or more application function libraries in the plurality of application function libraries can be stored in the one or more tables as binary large objects. Further, a structured query language can be used to query the storage location storing the application function library.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more user device computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include user devices and servers. A user device and server are generally, but not exclusively, remote from each other and typically interact through a communication network. The relationship of user device and server arises by virtue of computer programs running on the respective computers and having a user device-server relationship to each other.

Further non-limiting aspects or implementations are set forth in the following numbered examples:

Example 1: A method, comprising: receiving a request for a transaction over a blockchain network, the transaction comprising a transfer of assets between a target node to a recipient node, the target node and the recipient node being included in a blockchain network transmitting, a link to a first transaction operation to the recipient node; receiving a first result of the first transaction operation from the recipient node; transmitting, over the blockchain network, a token of the first result of the first transaction operation to trigger a second transaction operation; receiving a second result of the second transaction operation from the blockchain network; generating a pair of non-fungible tokens comprising encrypted metadata associated with the transaction comprising the second result of the second transaction operation; and transmitting one non-fungible token of the pair of non-fungible tokens to the target node and the other non-fungible token of the pair of non-fungible tokens to the recipient node.

Example 2: The method of example 1, wherein each non-fungible token of the pair of non-fungible tokens comprises contact information of the target node and the recipient node (and asset transaction information.

Example 3: The method of any one of the preceding examples, further comprising: determining that the transaction is authorized.

Example 4: The method of any one of the preceding examples, wherein determining that the transaction is authorized comprises determining that the target node is identified as an entity allowed to perform the second transaction operation.

Example 5: The method of any one of the preceding examples, wherein the second transaction operation comprises a shipment of at least one of the assets.

Example 6: The method of any one of the preceding examples, further comprising: monitoring completion of the shipment within a set shipment time period.

Example 7: The method of any one of the preceding examples, further comprising: monitoring completion of the first transaction operation, by the recipient node, within a set time period.

Example 8: The method of any one of the preceding examples, further comprising: receiving, from the recipient node, a refund request comprising an NFT identifying a past transaction; and processing the refund for the past transaction.

Example 9: The method of any one of the preceding examples, further comprising: determining a balance of an account of at least one of the target node and the recipient node.

Example 10: The method of any one of the preceding examples, wherein generating the pair of non-fungible tokens is queued in a chain of transactions.

Example 11: The method of any one of the preceding examples, wherein the chain of transactions are rearranged based on a history and priority of transactions.

Example 12: A non-transitory computer-readable storage medium comprising at least one program for execution by one or more processors of a first device, the at least one program including instructions which, when executed by the one or more processors, cause the first device to perform operations comprising: receiving a request for a transaction over a blockchain network, the transaction comprising a transfer of assets between a target node to a recipient node, the target node and the recipient node being included in a blockchain network transmitting, a link to a first transaction operation to the recipient node; receiving a first result of the first transaction operation from the recipient node; transmitting, over the blockchain network, a token of the first result of the first transaction operation to trigger a second transaction operation; receiving a second result of the second transaction operation from the blockchain network; generating a pair of non-fungible tokens comprising encrypted metadata associated with the transaction comprising the second result of the second transaction operation; and transmitting one non-fungible token of the pair of non-fungible tokens to the target node and the other non-fungible token of the pair of non-fungible tokens to the recipient node.

Example 13: A system, comprising: at least one computer-readable medium storing computer-executable instructions; and at least one processor, the at least one processor being configured to execute the computer executable instructions, the execution carrying out operations comprising: receiving a request for a transaction over a blockchain network, the transaction comprising a transfer of assets between a target node to a recipient node, the target node and the recipient node being included in a blockchain network transmitting, a link to a first transaction operation to the recipient node; receiving a first result of the first transaction operation from the recipient node; transmitting, over the blockchain network, a token of the first result of the first transaction operation to trigger a second transaction operation; receiving a second result of the second transaction operation from the blockchain network; generating a pair of non-fungible tokens comprising encrypted metadata associated with the transaction comprising the second result of the second transaction operation; and transmitting one non-fungible token of the pair of non-fungible tokens to the target node and the other non-fungible token of the pair of non-fungible tokens to the recipient node.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. For example, the logic flows can include different and/or additional operations than shown without departing from the scope of the present disclosure. One or more operations of the logic flows can be repeated and/or omitted without departing from the scope of the present disclosure. Other implementations can be within the scope of the following claims.

1. A method, comprising:
receiving a request for a transaction over a blockchain network, the transaction comprising a transfer of assets between a target node to a recipient node, the target node and the recipient node being included in a blockchain network transmitting, a link to a first transaction operation to the recipient node;
receiving a first result of the first transaction operation from the recipient node;
transmitting, over the blockchain network, a token of the first result of the first transaction operation to trigger a second transaction operation;
receiving a second result of the second transaction operation from the blockchain network;
generating a pair of non-fungible tokens comprising encrypted metadata associated with the transaction comprising the second result of the second transaction operation; and
transmitting one non-fungible token of the pair of non-fungible tokens to the target node and the other non-fungible token of the pair of non-fungible tokens to the recipient node.

2. The method of claim 1, wherein each non-fungible token of the pair of non-fungible tokens comprises contact information of the target node and the recipient node (and asset transaction information.

3. The method of claim 1, further comprising:
determining that the transaction is authorized.

4. The method of claim 3, wherein determining that the transaction is authorized comprises determining that the target node is identified as an entity allowed to perform the second transaction operation.

5. The method of claim 1, wherein the second transaction operation comprises a shipment of at least one of the assets.

6. The method of claim 5, further comprising:
monitoring completion of the shipment within a set shipment time period.

7. The method of claim 1, further comprising:
monitoring completion of the first transaction operation, by the recipient node, within a set time period.

8. The method of claim 1, further comprising:
Receiving, from the recipient node, a refund request comprising a non-fungible token identifying a past transaction; and
processing the refund for the past transaction.

9. The method of claim 1, further comprising:
determining a balance of an account of at least one of the target node and the recipient node.

10. The method of claim 1, wherein generating the pair of non-fungible tokens is queued in a chain of transactions.

11. The method of claim 10, wherein the chain of transactions is rearranged based on a history and priority of transactions.

12. A non-transitory computer-readable storage medium comprising at least one program for execution by one or more processors of a first device, the at least one program including instructions which, when executed by the one or more processors, cause the first device to perform operations comprising:
receiving a request for a transaction over a blockchain network, the transaction comprising a transfer of assets between a target node to a recipient node, the target node and the recipient node being included in a blockchain network transmitting, a link to a first transaction operation to the recipient node;
receiving a first result of the first transaction operation from the recipient node;
transmitting, over the blockchain network, a token of the first result of the first transaction operation to trigger a second transaction operation;
receiving a second result of the second transaction operation from the blockchain network;
generating a pair of non-fungible tokens comprising encrypted metadata associated with the transaction comprising the second result of the second transaction operation; and
transmitting one non-fungible token of the pair of non-fungible tokens to the target node and the other non-fungible token of the pair of non-fungible tokens to the recipient node.

13. A system, comprising:
at least one computer-readable medium storing computer-executable instructions; and
at least one processor, the at least one processor being configured to execute the computer executable instructions to perform operations comprising:
receiving a request for a transaction over a blockchain network, the transaction comprising a transfer of assets between a target node to a recipient node, the target node and the recipient node being included in a blockchain network
transmitting, a link to a first transaction operation to the recipient node;
receiving a first result of the first transaction operation from the recipient node;
transmitting, over the blockchain network, a token of the first result of the first transaction operation to trigger a second transaction operation;
receiving a second result of the second transaction operation from the blockchain network;
generating a pair of non-fungible tokens comprising encrypted metadata associated with the transaction comprising the second result of the second transaction operation; and
transmitting one non-fungible token of the pair of non-fungible tokens to the target node and the other non-fungible token of the pair of non-fungible tokens to the recipient node.

14. The method of claim 1, further comprising:
adding a first delay time after receiving the first result of the first transaction operation; and
verifying a validity of the first transaction operation at predefined time intervals during the first delay time.

15. The method of claim 14, further comprising:
minting the token of the first result in response to verifying the validity of the first transaction.

16. The method of claim 14, further comprising:
determining whether a maximum number of retries to validate the first transaction operation has been reached if the validity is not confirmed, and
determining that the first transaction operation has failed if the maximum number of retries has been reached.

17. The method of claim 1, further comprising:
adding a second delay time corresponding to a set second time interval before generating the pair of non-fungible tokens, and
verifying a validity of generating the pair of non-fungible tokens at predefined time intervals during the second delay time.

18. The method of claim 17, further comprising:
generating the pair of non-fungible tokens in response to verifying the validity of generating the pair of non-fungible tokens.

19. The method of claim 17, further comprising:
determining whether a maximum number of retries to validate the generating the pair of non-fungible tokens has been reached if the validity is not confirmed, and
determining that the generating the pair of non-fungible tokens has failed if the maximum number of retries has been reached.

20. The method of claim 8, further comprising:
determining whether a predefined period of time has lapsed since a completion of the past transaction; and
denying the refund for the past transaction in response to that the predefined period of time has lapsed.
